(19) United States
(12) Patent Application Publication
(10) Pub. No.: US 2022/0058055 A1
(43) Pub. Date: Feb. 24, 2022

(54) TASK CONTROL APPARATUS AND TASK CONTROL METHOD

(71) Applicant: FUJITSU LIMITED, Kawasaki-shi (JP)

(72) Inventors: Kouichirou AMEMIYA, Kawasaki (JP); Kento Ikkaku, Kawasaki (JP); MIHO KAWANO, Hamamatsu (JP); Kenichi Nagasue, Fukuoka (JP)

(73) Assignee: FUJITSU LIMITED, Kawasaki-shi (JP)

(21) Appl. No.: 17/331,688

(22) Filed: May 27, 2021

(30) Foreign Application Priority Data
Aug. 20, 2020 (JP) 2020-139280

(51) Int. Cl. G06F 9/48; G06F 9/54; G06F 16/901

(52) U.S. Cl. CPC G06F 9/4887; G06F 16/901; G06F 9/546

(57) ABSTRACT

A task control apparatus includes: a memory; and a processor coupled to the memory and configured to: assign, to each request for data collection, an index based on acceptance time and a delay period allowable in data collection; input the request to a queue in order of the index; extract, in a case where a transmission timing of data collection of the request is to be delayed, the request from the queue; and re-input the request to the queue by using an index based on a period for which the transmission timing is to be delayed and an extraction pace at which requests are extracted from the queue.

### CROSS-REFERENCE TO RELATED APPLICATION

This application is based upon and claims the benefit of priority of the prior Japanese Patent Application No. 2020-139280, filed on Aug. 20, 2020, the entire contents of which are incorporated herein by reference.

### FIELD

The embodiment discussed herein is related to a task control apparatus and the like.

### BACKGROUND

In recent years, a system has been studied that collects data (such as video data) generated by distributed devices (such as vehicles) in accordance with a request from a service. It is known that time taken for collecting data varies depending on characteristics of a data source and a location of the data source and that collected data values change over time. For example, in a case where a mobility device serves as a data source, a wireless network to which the mobility device is coupled changes depending on the location and the performance of the wireless network changes depending on a degree of congestion.

Related art is disclosed in Japanese Laid-open Patent Publication No. 2008-40718 and Japanese Laid-open Patent Publication No. 2018-63672.

### SUMMARY

According to an aspect of the embodiments, a task control apparatus includes: a memory; and a processor coupled to the memory and configured to: assign, to each request for data collection, an index based on acceptance time and a delay period allowable in data collection; input the request to a queue in order of the index; extract, in a case where a transmission timing of data collection of the request is to be delayed, the request from the queue; and re-input the request to the queue by using an index based on a period for which the transmission timing is to be delayed and an extraction pace at which requests are extracted from the queue.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a functional configuration of a control apparatus according to an embodiment;

FIG. 2 is a diagram illustrating an example of a data-processing-request accepting process according to the embodiment;

FIG. 3 is a diagram illustrating a first example of a data-processing-request scheduler process according to the embodiment;

FIG. 4 is a diagram illustrating a second example of the data-processing-request scheduler process according to the embodiment;

FIG. 5 is a diagram illustrating an example of a data structure of statistical information;

FIG. 6 is a diagram illustrating an example of a data structure of data-transmission-source location information;

FIG. 7 is a diagram illustrating an example of a data structure of data information;

FIG. 8 is a diagram illustrating an example of a data structure of data-collection-task state management information;

FIG. 9 is a diagram illustrating an example of a data structure of collected data store information;

FIG. 10 is a diagram illustrating an example of a data processing request;

FIG. 11 is a diagram illustrating an example of a data processing request queue entry;

FIG. 12 is a diagram illustrating an example of a request of a data collection task (to a data source);

FIG. 13 is a diagram illustrating an example of a data collection task response;

FIG. 14 is a diagram illustrating an example of a data processing request response (to a service);

FIGS. 15A and 15B are a flowchart illustrating an example of the data-processing-request accepting process according to the embodiment;

FIGS. 16A and 16B are a flowchart illustrating an example of the data-processing-request scheduler process according to the embodiment;

FIG. 17 is a flowchart illustrating an example of a data reception process according to the embodiment;

FIG. 18 is a flowchart illustrating an example of a data processing process according to the embodiment;

FIG. 19 is a flowchart illustrating an example of a transmission-source-location-information collection process according to the embodiment;

FIGS. 20A and 20B are a flowchart illustrating an example of a statistical information generation process according to the embodiment;

FIG. 21 is a diagram illustrating an example of a computer that executes a control program;

FIG. 22 is a diagram illustrating a reference example of a distributed data collection system;

FIG. 23 is a diagram illustrating a reference example of a flow of distributed data collection;

FIG. 24 is a diagram for describing a token supply amount updated by a token manager;

FIG. 25 is a diagram illustrating variations of a data collection delay;

FIG. 26 is a diagram for describing a load imposed on resources due to variations of the data collection delay; and

FIG. 27 is a diagram for describing a reason why simultaneous reception of pieces of collected data is hindered.

### DESCRIPTION OF EMBODIMENTS

For example, when a request to a server (including a data source) is transmitted, it is determined whether or not to permit transfer of the request to the server so that the server is not overloaded. For example, when a system registers, as a message, a process that involves a long processing time in a queue, the process is divided and a plurality of messages are created so that a processing load of the system becomes approximately uniform.

There is a case where, in accordance with a data processing request, from a service, involving a delay request for completion of processing, data is collected and processed by a deadline indicated by the delay request. In such a case, if a delay occurs in collecting data, leveling performed in accordance with the delay request at the time of transmission to the data source collapses. This leads to an additional calculation resource for fully receiving the resulting load peak. As a result of occurrence of a time difference in collecting pieces of data subjected to data processing, data waiting for being processed stays. This leads to an additional memory. For example, the occurrence of a delay in collecting data causes an issue in that a load is imposed on the resources.

In one aspect, simultaneous reception of pieces of collected data subjected to data processing without imposing a load on resources may be implemented.

An embodiment of a task control apparatus and a task control method disclosed in the present application will be described in detail below based on the drawings. Note that the present disclosure is not limited to the embodiment.

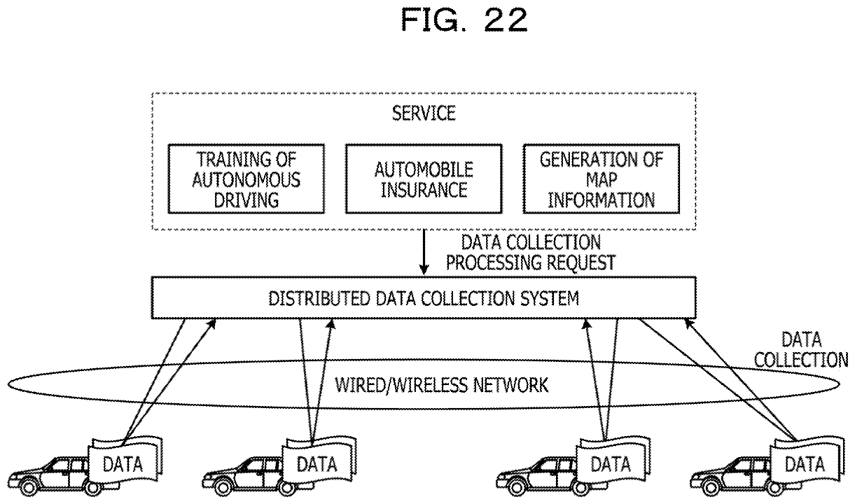

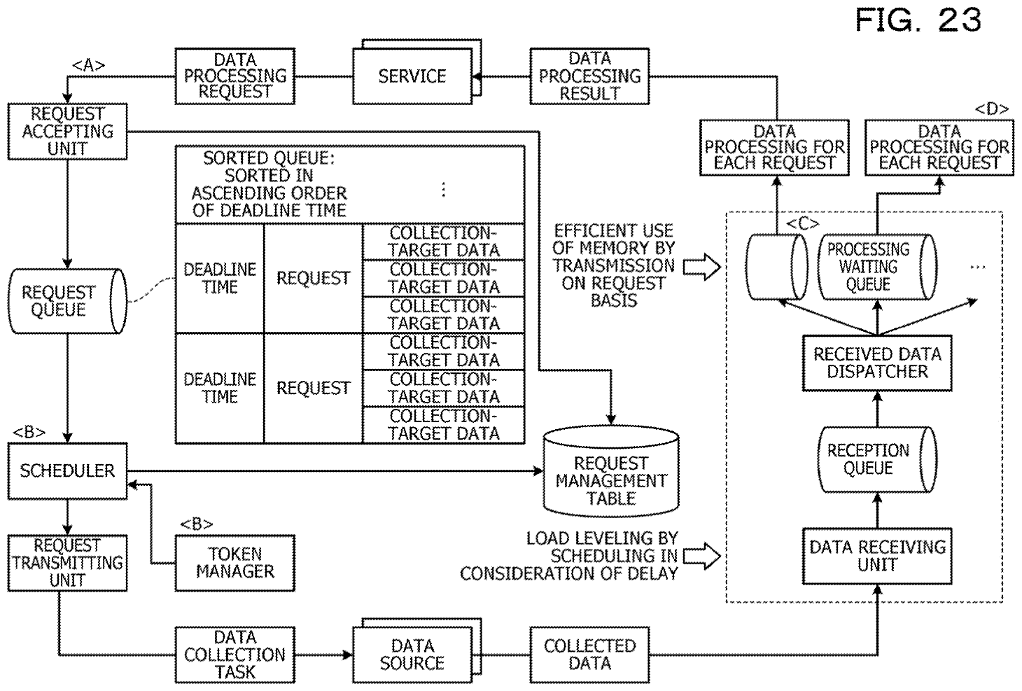

First, a reference example of a distributed data collection system that collects data generated by distributed devices (such as vehicles) in accordance with a request from a service will be described with reference to FIGS. 22 and 23. FIG. 22 is a diagram illustrating a reference example of a distributed data collection system. As illustrated in FIG. 22, the service transmits a data collection processing request (data processing request) at a desired timing in order to collect desired data. In accordance with the data collection processing request (data processing request) from the service, the distributed data collection system collects data from data-collection-target devices via a network.

FIG. 23 is a diagram illustrating a reference example of a flow of distributed data collection. As illustrated in FIG. 23, in the distributed data collection system, a request accepting unit receives a data processing request from the service (<A>). The data processing request includes a deadline for completion of processing and an identifier (ID) of a collection-target source data group. The request accepting unit inputs the received data processing request to a request queue. The request queue accumulates the data processing requests sorted in ascending order of deadline time.

A scheduler, together with a token manager, controls transmission of the data processing requests so that the load is leveled while the deadline is met (<B>). In this example, the scheduler performs request scheduling by using earliest deadline first (EDF) scheduling. The term “EDF scheduling” used herein refers to a scheduling algorithm for processing requests sequentially from a request having the closest deadline time. Therefore, the scheduler extracts data processing requests from the request queue in order from the request with the closest deadline time while leveling the load, and outputs the data processing requests to a request transmitting unit. At this time, the scheduler updates the states of the requests in a request management table. The request transmitting unit collectively transmits data collection tasks belonging to the data processing request at the same time in order to minimize a period for which the request waiting for being processed is held in the request queue.

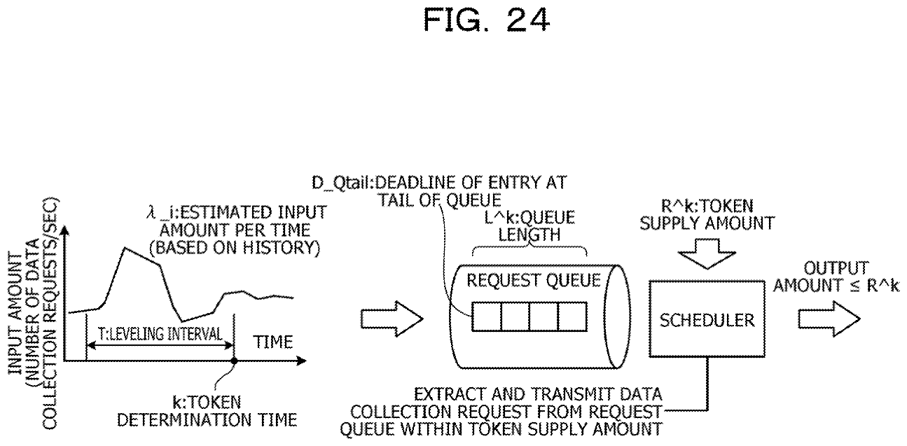

The token manager periodically updates a token supply amount per unit time. The token supply amount is obtained by using equation Rₖ=Max(R₁^{k}, R₂^{k}). FIG. 24 is appropriately referred to in order to describe the token supply amount updated by the token manager. FIG. 24 is a diagram for describing a token supply amount updated by a token manager.

A symbol k of Rₖ denotes token determination time when the token supply amount is determined. R₁^{k} is obtained based on equation (1). As indicated by the request queue in FIG. 24, L^{K} denotes a length of requests, for example, the number of requests in the queue. D_{Qtail} denotes a deadline for the entry at the tail of the queue. For example, a token supply amount R₁ is determined such that the entry at the end of the queue is transmitted by the deadline, and is introduced so that the deadline is to be met.

$${R}_{1}^{k} = \frac{{L}^{k}}{{D}_{Qtail}} \qquad ( 1 )$$

R₂^{k} is obtained based on equation (2). L^{K} indicates a length of requests, for example, the numbers of requests in the queue. As indicated by a graph in FIG. 24, λᵢ denotes an expected input amount per period (the number of data processing requests/second). T denotes a leveling interval. The input amount (the number of data processing requests/second) is an input amount of requests input to the queue, and incessantly changes such that the input amount has a peak and an off-peak. A token supply amount R₂ is determined based on an average value of the load expected in a future interval, and is introduced for leveling.

$${R}_{2}^{k} = \frac{{L}^{k} + {\sum }_{i = k + 1}^{T} {λ}_{i}}{T} \qquad ( 2 )$$

As illustrated in FIG. 24, the scheduler extracts and transmits the data processing request from the request queue within the range of the token supply amount R^{k} periodically updated by the token manager. For example, the scheduler outputs (transmits) the data processing request such that an output amount is less than or equal to the token supply amount R^{k}.

Referring back to FIG. 23, a target data source that has received a data collection task belonging to the data processing request transmits collected data.

In the distributed data collection system, a data receiving unit receives the collected data and inputs the collected data to a reception queue.

A received data dispatcher extracts the received data in an executable state from the reception queue and inputs the received data to a processing waiting queue. The processing waiting queue (in-memory) holds the data until collection of data subjected to data processing is completed (<C>). For example, the processing waiting queue (in-memory) holds the data until collection of data relating to the data collection tasks belonging to the data processing request is completed.

A data processing unit performs processing upon data becoming complete, and returns, as a response, the processing result to the service (<D>).

As described above, the scheduler performs transmission control so that the load is leveled in consideration of the deadline. Thus, the load is leveled also on the reception side. The request transmitting unit collectively transmits the data collection tasks belonging to the data processing request at the same time. Thus, the in-memory is efficiently used also on the reception side.

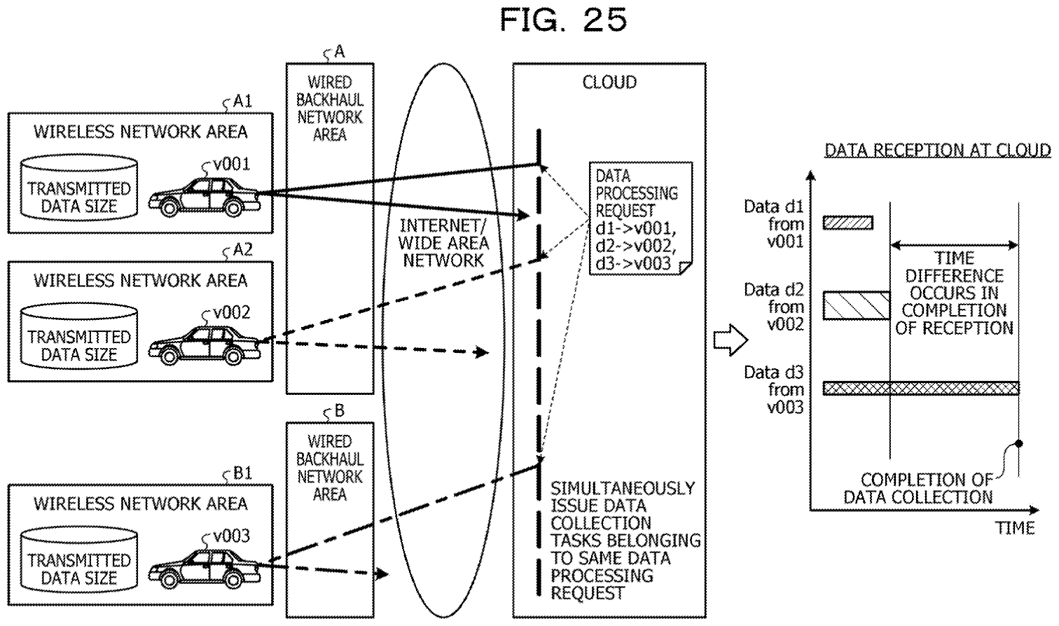

However, time taken for collecting data varies depending on characteristics of the data source and a location of the data source. In addition, collected data values change over time. FIG. 25 is a diagram illustrating variations of a data collection delay. FIG. 25 illustrates a case where mobility devices serve as data sources. A mobility device v001 is moving in a wireless network area A1. A mobility device v002 is moving in a wireless network area A2. A mobility device v003 is moving in a wireless network area B1. It is assumed that, in such a case, the data processing request is a request for collecting data d1 from the mobility device v001, data d2 from the mobility device v002, and data d3 from the mobility device v003. The scheduler collectively issues data collection tasks belonging to the same data processing request at the same time.

On the data reception side, a time difference occurs in completion (data collection completion) of reception of the data d1 from the mobility device v001, the data d2 from the mobility device v002, and the data d3 from the mobility device v003. This is because a wireless network to which the mobility device is coupled changes depending on the location of the mobility device and the performance of the wireless network changes depending on a degree of congestion. The delay in collecting data varies depending on characteristics of the data source and the location of the data source.

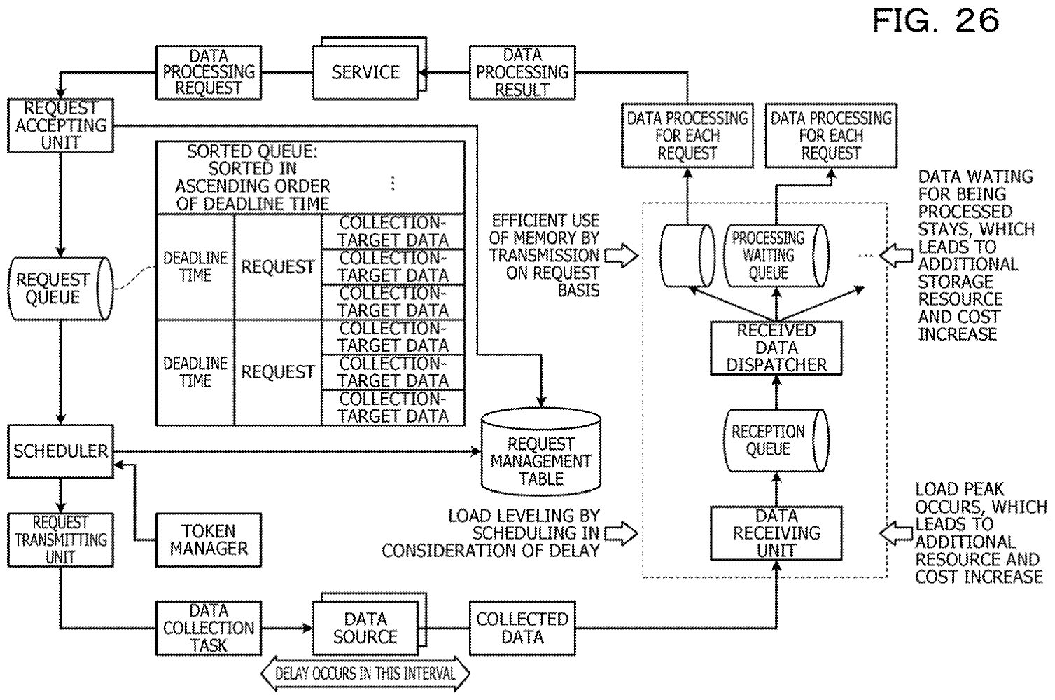

When the delay in collecting data varies, a load is imposed on resources. FIG. 26 is a diagram for describing a load imposed on resources due to variations of the data collection delay. As illustrated in FIG. 26, if a delay occurs in collecting data from a data source, leveling performed at the time of transmission collapses. This leads to an additional calculation resource for fully receiving the resulting load peak. Consequently, the cost increases. Since leveling performed at the time of transmission collapses, simultaneous reception of pieces of collected data by the data collection tasks belonging to the same data processing request is hindered.

As a result of occurrence of a time difference in collecting pieces of data subjected to data processing, data waiting for being processed stays. This leads to an additional memory. Consequently, the cost increases. For example, the occurrence of a delay in collecting data causes an issue in that a load is imposed on the resources.

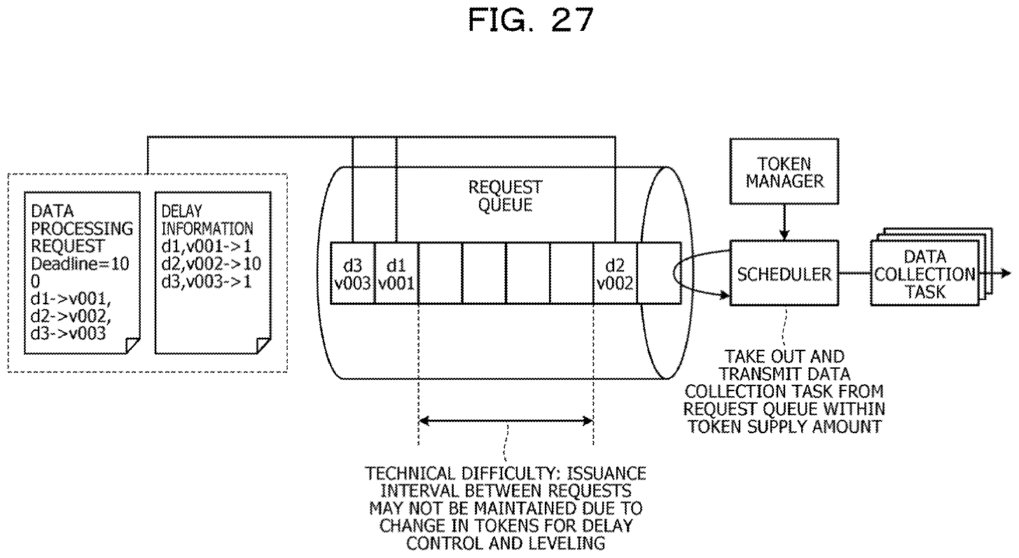

The reason why simultaneous reception of pieces of collected data is hindered will be described with reference to FIG. 27. FIG. 27 is a diagram for describing a reason why simultaneous reception of pieces of collected data is hindered. As illustrated in FIG. 27, there are a plurality of data collection tasks belonging to a data processing request. It is assumed that delay information is calculated for each of the data collection tasks in order for these data collection tasks to complete collection of data at the same time. It is assumed that the delay information is calculated from the size of the collected data for each of the data collection tasks and from statistical information created in advance. The statistical information may be, for example, information obtained by measuring a delay or throughput for each data source and for each location in the past.

In such a circumstance, the request accepting unit sets a deadline in consideration of the delay information and stores the request in the request queue. However, there is a case where the token supply amount for leveling varies depending on the delay. Therefore, an issuance interval may not be maintained between the data collection tasks because of the changes of the data collection delays for the respective data sources. As a result, simultaneous reception of pieces of collected data by the plurality of data collection tasks belonging to a data processing request is hindered.

Accordingly, in an embodiment, a control apparatus that implements simultaneous reception of pieces of collected data without imposing a load on resources will be described.

### Embodiment

[Configuration of Control Apparatus According to Embodiment]

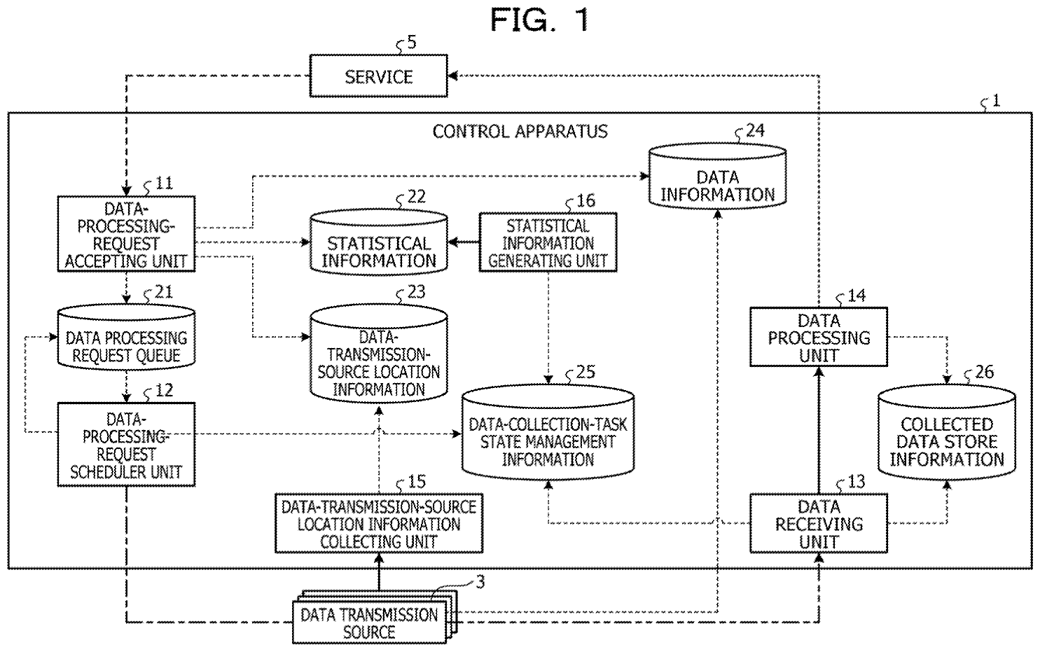

FIG. 1 is a diagram illustrating a functional configuration of a control apparatus according to an embodiment. As illustrated in FIG. 1, a control apparatus 1 accepts a data processing request from a service 5, transmits data collection tasks belonging to the data processing request to respective data transmission sources 3, performs processing upon data collected from the data transmission sources 3 becoming complete, and returns the processing result as a response to the service 5. The data transmission sources 3 are mobility devices having a communication function and are, for example, vehicles.

The control apparatus 1 includes a data-processing-request accepting unit 11, a data-processing-request scheduler unit 12, a data receiving unit 13, a data processing unit 14, a data-transmission-source location information collecting unit 15, and a statistical information generating unit 16. The control apparatus 1 also includes a data processing request queue 21, statistical information 22, data-transmission-source location information 23, data information 24, data-collection-task state management information 25, and collected data store information 26. The data-processing-request accepting unit 11 is an example of an input unit. The data-processing-request scheduler unit 12 is an example of a re-input unit.

The data processing request queue 21 is a queue used for time-staggered transmission of a data processing request (request). The data processing request queue 21 is a priority queue in which requests are sorted in ascending order of the index value. For example, the data processing request queue 21 is an EDF queue in which requests are sorted in order from the earliest deadline time.

The statistical information 22 is information obtained by accumulating, for each data source serving as a data transmission source, as statistics, a delay time and a throughput in transmission of data at a geographical location in a time slot. The data source is a mobility device. The statistical information 22 is periodically or aperiodically updated by the statistical information generating unit 16.

The data-transmission-source location information 23 is information storing the geographical location of the data source serving as the data transmission source. The geographical location indicates, for example, a latitude and a longitude. The data-transmission-source location information 23 is updated by the data-transmission-source location information collecting unit 15.

The data information 24 is information on data held by the data source serving as the data transmission source. The data information 24 includes a size of each piece of data and an attribute of the data. It is sufficient that the data information 24 is generated and held in advance.

The data-collection-task state management information 25 is information for managing the state of data collection performed by the data collection task belonging to the data processing request. The data-collection-task state management information 25 is updated by the data-processing-request scheduler unit 12 and the data receiving unit 13.

The collected data store information 26 is information storing the body of the collected data. Data is stored in the collected data store information 26 by the data receiving unit 13 and is processed by the data processing unit 14.

The data-processing-request accepting unit 11 accepts a data processing request. The data processing request includes, for example, collection-target data information and a data-processing-delay request period. The collection-target data information is information of a data source ID for uniquely identifying a data source serving as the data transmission source 3 and of a data ID for uniquely identifying collection-target data. There are as many pieces of collection-target data information as the number of pieces of collection-target data. The data-processing-delay request period indicates a request period from issuance of a data processing request to completion of processing. The data-processing-request accepting unit 11 obtains deadline time obtained by adding the data-processing-delay request period included in the data processing request to the request acceptance time.

The data-processing-request accepting unit 11 calculates, for each piece of collection-target data information, a response delay in collecting data. For example, the data-processing-request accepting unit 11 acquires, by using the data-transmission-source location information 23, the current location of the data source serving as the data transmission source 3. The data-processing-request accepting unit 11 acquires, by using the statistical information 22, a delay and a throughput for the data source at the current location in the current time slot. The data-processing-request accepting unit 11 acquires, from the data information 24, the size of collection-target data. The data-processing-request accepting unit 11 calculates, by using the delay and the throughput for the data source and the size of the data, a delay in collecting data for the data source. The data-processing-request accepting unit 11 obtains the largest delay among the delays in collecting data that are calculated for the respective pieces of collection-target data information. The data-processing-request accepting unit 11 calculates delays to be added for respective pieces of collection-target data information at the time of transmission, by using the delays in collecting data for the respective data sources of the respective pieces of collection-target data and the largest delay so that the pieces of collection-target data may be collected at the same time. The delays to be added for the respective pieces of collection-target data information at the time of transmission may be, for example, values obtained by subtracting the respective delays in collecting data from the largest delay. For example, a piece of collection-target data with the largest delay is to be transmitted earlier than the other pieces of collection-target data. Thus, the delay to be added at the time of transmission is calculated to be 0. Pieces of collection-target data with non-largest delays are transmitted later, by the respective delays, than the piece collection-target data with the largest delay. This enables all the pieces of collection-target data to be collected at the same time.

The data-processing-request accepting unit 11 generates an entry (data processing request queue entry) to the data processing request queue 21. The data processing request queue entry includes, for example, collection-target data information and a data-processing-delay request period in association with an index and a data processing request ID. Deadline time is set as the index. Content of the data processing request is set as the data processing request ID, the data source ID and the data ID in the collection-target data information, and the data-processing-delay request period. In the collection-target data information, transmission additional information and expected transmission time are further set for each piece of collection-target data information. As the transmission additional information for each piece of collection-target data information, the corresponding delay is set. As the expected transmission time for each piece of collection-target data information, expected time when the corresponding data collection task is transmitted is set. However, it is sufficient that an initial value of “−1” is set. The data-processing-request accepting unit 11 inputs the generated data processing request queue entry to the data processing request queue 21.

[Example of Data-Processing-Request Accepting Process]

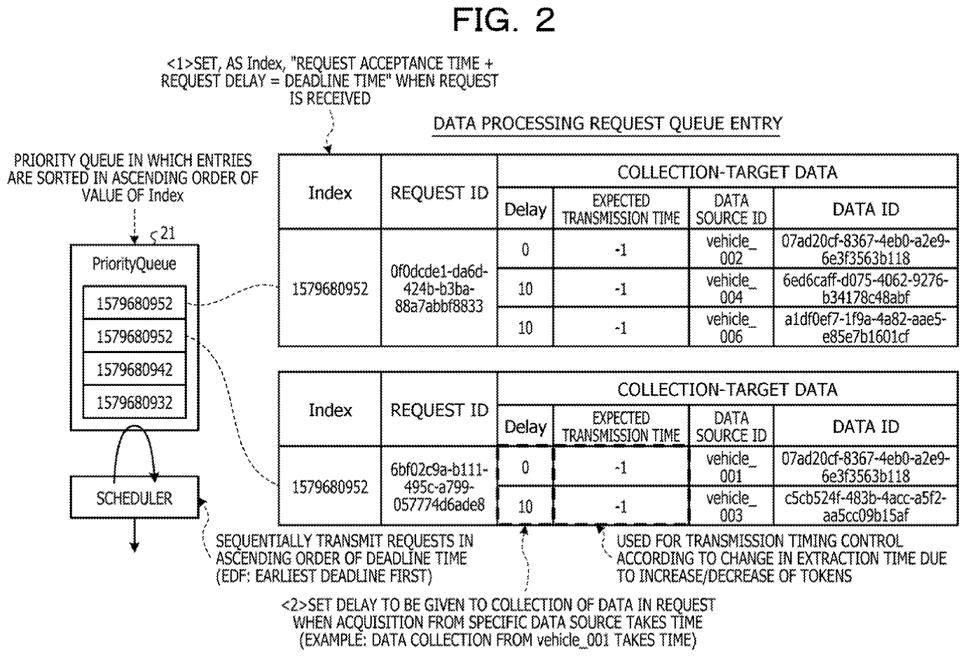

An example of a data-processing-request accepting process according to the embodiment will be described with reference to FIG. 2. FIG. 2 is a diagram illustrating an example of the data-processing-request accepting process according to the embodiment. As illustrated in FIG. 2, in response to accepting a data processing request, the data-processing-request accepting unit 11 obtains deadline time of the request by adding the data-processing-delay request period in the request to the request acceptance time, and sets the deadline time as the index of the request (<1>). A request on the upper side is a request in a case where pieces of data of data sources vehicle_002, vehicle_004, and vehicle_006 are collected as pieces of collection-target data. The deadline time is set as the index of such a request. A request on the lower side is a request in a case where pieces of data of data sources vehicle_001 and vehicle_003 are collected as pieces of collection-target data. The deadline time is set as the index of such a request.

When it takes time to acquire data from a specific data source, the data-processing-request accepting unit 11 sets a delay to be given to collection of the data in the request (<2>). For example, the data-processing-request accepting unit 11 acquires, by using the data-transmission-source location information 23 and the statistical information 22, a delay and a throughput of the data source at the current location in the time slot. The data-processing-request accepting unit 11 acquires, from the data information 24, the size of collection-target data. The data-processing-request accepting unit 11 calculates, by using the delay and the throughput of the data source at the current location in the time slot and using the size of the data, a delay in collecting the data for the data source. The data-processing-request accepting unit 11 obtains the largest delay among the delays in collecting data that are calculated for the respective pieces of collection-target data information. The data-processing-request accepting unit 11 calculates delays to be added for respective pieces of collection-target data information at the time of transmission, by using the delays in collecting data for the respective data sources of the respective pieces of collection-target data and using the largest delay so that the pieces of collection-target data may be collected at the same time. The delay may be, for example, a value obtained by subtracting the delay in collecting data from the largest delay. For example, acquisition of the piece of collection-target data with the largest delay takes longer than acquisition of the other pieces of data in the entry. Thus, the delay to be added at the time of transmission is calculated to be “0”. In the request on the upper side, a delay in collecting data of the data source vehicle_002 is set to “0”, and a delay in collecting data of the data sources vehicle_004 and vehicle_006 is set to “10”. Acquisition of the data of the data source vehicle_002 takes longer than acquisition of the pieces of data of the data sources vehicle_004 and vehicle_006. Thus, the delay to be added at the time of transmission is calculated to be “0”. The expected transmission time is set to, for example, “−1” as the initial value.

The data-processing-request accepting unit 11 inputs the data processing request queue entry to the data processing request queue 21. In the data processing request queue 21, the data processing request queue entries are sorted in ascending order of the index value.

Referring back to FIG. 1, in a case of delaying the transmission timing of the collection-target data information included in the entry input to the data processing request queue 21, the data-processing-request scheduler unit 12 calculates the index and the expected transmission time and re-inputs the entry to the data processing request queue by using the calculated index. For example, the data-processing-request scheduler unit 12 extracts a data processing request queue entry from the data processing request queue 21. A case where a value greater than “0” is set as the delay of the collection-target data information is a case where the transmission timing of the collection-target data information is to be delayed. Thus, the data-processing-request scheduler unit 12 performs the following processing. For the transmission-target data information, the data-processing-request scheduler unit 12 sets the expected transmission time to time obtained by adding the delay to the current time when the entry is extracted (current extraction time). The data-processing-request scheduler unit 12 calculates the index based on the delay and the current token supply amount. The data-processing-request scheduler unit 12 re-inputs the data collection task of this collection-target data information to the data processing request queue 21 by using the calculated index. In a case where “0” is set as the delay in the collection-target data information, the data-processing-request scheduler unit 12 may transmit the data collection task of this collection-target data information if the expected transmission time is the initial value or is before the current time.

The data-processing-request scheduler unit 12 further extracts the data collection task of the collection-target data information from the data processing request queue 21. If the expected transmission time is after the current time, the data-processing-request scheduler unit 12 re-calculates the index, based on the expected transmission time, the current time, and the current token supply amount. The data-processing-request scheduler unit 12 re-inputs the data collection task of this collection-target data information to the data processing request queue 21 by using the re-calculated index. This is performed to control the transmission timing in accordance with a change in the extraction time due to a change in the token supply amount if the expected transmission time is a later time point. For example, this is performed to level the load on the reception side. The cause of the change in the token supply amount is considered to be an increase or decrease in the amount of power or a change in the number of input entries (in the queue).

[Example of Data-Processing-Request Scheduler Process]

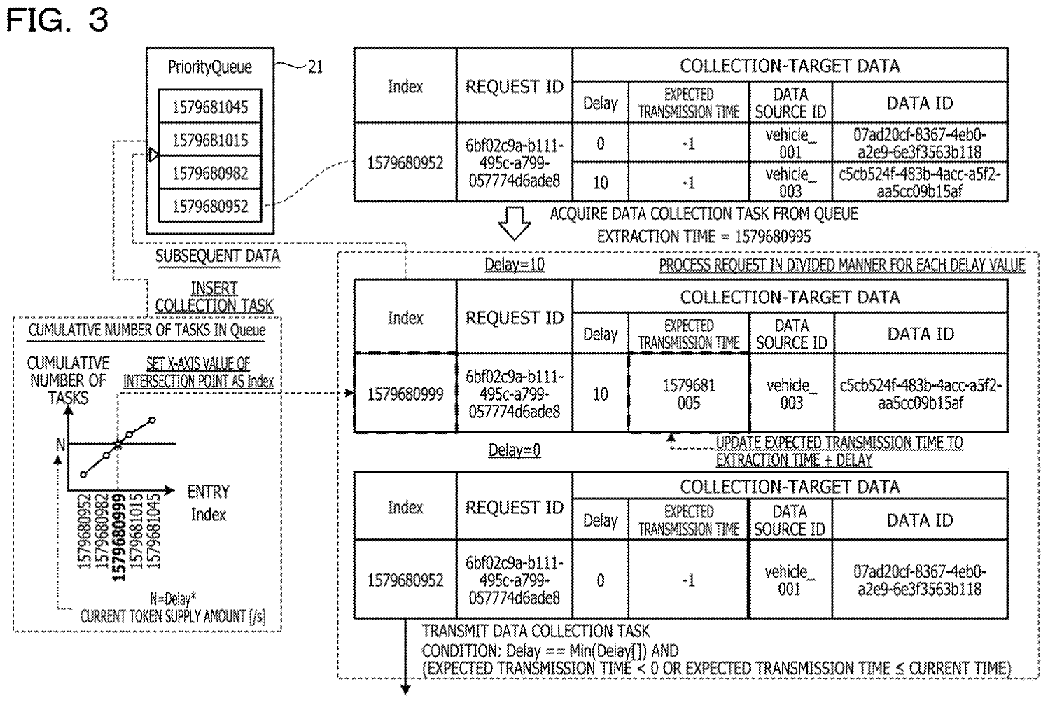

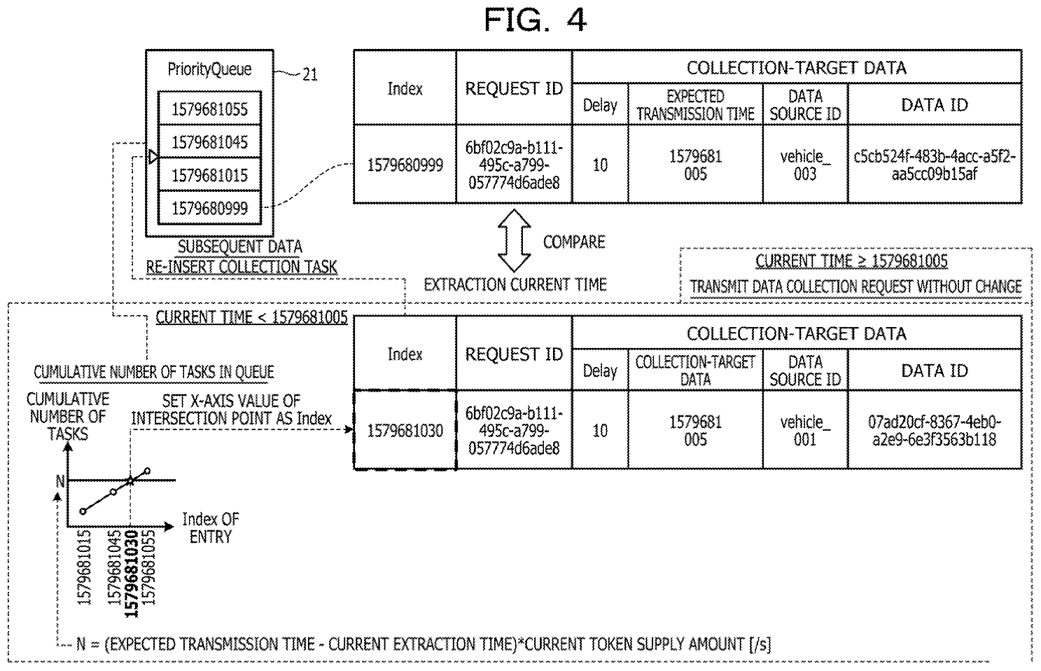

An example of a data-processing-request scheduler process according to the embodiment will be described with reference to FIGS. 3 and 4. FIG. 3 is a diagram illustrating a first example of the data-processing-request scheduler process according to the embodiment. As illustrated in FIG. 3, in the priority queue (the data processing request queue 21), the entry with the smallest index “1579680952” is located at the head. The entry is an entry of a request in a case where pieces of data of the respective data sources vehicle_001 and vehicle_003 are collected as pieces of collection-target data. The delay for the data source vehicle_001 is set to “0”, and the delay for the data source vehicle_003 is set to “10”. The expected transmission time is set to “−1” as the initial value.

The data-processing-request scheduler unit 12 extracts the entry with the smallest index “1579680952” from the data processing request queue 21.

The data-processing-request scheduler unit 12 immediately transmits the collection-target data information as the data collection task if the collection-target data information satisfies a condition of “(1) AND ((2) OR (3))” among the pieces of collection-target data information. (1) indicates that the delay is the smallest among the delays for the pieces of collection-target data in the entry. (2) indicates that the expected transmission time is the initial value. (3) indicates that the expected transmission time is before the current time. In this case, the delay of “0” is the smallest among the delays for the pieces of collection-target data information in the entry. Thus, the collection-target data information with the delay of “0” corresponds to the case (1). Since the expected transmission time is the initial value of “−1”, which thus corresponds to the case (2). Therefore, since the collection-target data information with the delay of “0” satisfies the condition, the data-processing-request scheduler unit 12 immediately transmits the collection-target data information as the data collection task.

If the collection-target data information does not satisfy the above condition among the pieces of collection-target data information, the data-processing-request scheduler unit 12 performs a process of determining the location at which the entry of the collection-target data information is to be re-inserted in the data processing request queue 21 in the following manner. The collection-target data information with the delay of “10” does not satisfy (1) and thus the condition because the delay is not the smallest among the delays for the pieces of collection-target data information in the entry. Thus, the data-processing-request scheduler unit 12 performs the process of determining the location at which the entry of the collection-target data information with the delay of “10” is to be re-inserted in the data processing request queue 21.

The process of determining the location at which the entry of the collection-target data information is to be re-inserted in the data processing request queue 21 is as follows. The data-processing-request scheduler unit 12 calculates the index based on the delay and the current token supply amount, and re-inserts the entry of this collection-target data at the location corresponding to the calculated index in the data processing request queue 21. For example, in order to immediately transmit a data collection task and then transmit a data collection task after a delay (d) with the current token supply amount (TP), the entry is to be inserted at a location where the number of pieces of collection-target data is equal to the number (N) (=d×TP) in the data processing request queue 21. If the entry is inserted at this location, the inserted entry comes at the head after the time d×TP/TP=d. Thus, the data collection task may be transmitted with the delay d.

In order to determine the insertion location, information for managing the number of entries stored in the data processing request queue 21 is held. This information is for managing a relationship between the index value of an entry in the data processing request queue 21 and the cumulative number of entries up to the entry having the index value. A function, which is f(N), for obtaining an index value from the cumulative number of entries is obtained. For example, the data processing request queue 21 is scanned, and an index value in the queue and a cumulative value of the number of entries up to the entry having the index value are plotted. As a result, an approximate curve is obtained as this function. The data-processing-request scheduler unit 12 obtains a new index value by using N and the function f(N). The data-processing-request scheduler unit 12 re-inserts the entry at the location for the new index value in the data processing request queue 21 in which the entries are sorted in ascending order of the index value.

In this example, as indicated by a graph on the lower left side in FIG. 3, a function f(x) for obtaining an index value is represented by plotting each index value in the data processing request queue 21 and the cumulative value of the number of entries up to the entry having the index value. N is equal to “10”× the current token supply amount, where “10” indicates the delay. The data-processing-request scheduler unit 12 obtains, by using this function f(x) and N, x corresponding to N, for example, a new index value “1579680999”. The data-processing-request scheduler unit 12 processes the collection-target data information with the delay of “10” in a divided manner, and generates an entry with the index “1579680999” and with expected transmission time “1579681005” that is equal to the current time “1579680995”+the delay (“10”). The data-processing-request scheduler unit 12 re-inserts the newly generated entry at the location of the index “1579680999” in the data processing request queue 21.

Thus, for an entry including a plurality of pieces of collection-target data, the data-processing-request scheduler unit 12 is able to transmit a data collection task with no delay and then transmit a data collection task with a delay after the delay. As a result, the data-processing-request scheduler unit 12 enables simultaneous reception of a plurality of pieces of collection-target data in the entry.

FIG. 4 is a diagram illustrating a second example of the data-processing-request scheduler process according to the embodiment. As illustrated in FIG. 4, an entry with the smallest index “1579680999” is located at the head in the data processing request queue 21. The entry is an entry of a request in a case where data of the data source vehicle_003 is collected as the collection-target data. For the data source vehicle_003, “10” is set as the delay and “1579681005” is set as the expected transmission time.

The data-processing-request scheduler unit 12 extracts the entry having the smallest index “1579680999” from the data processing request queue 21.

If the condition of “(1) AND ((2) OR (3))” is satisfied when the entry is extracted, the data-processing-request scheduler unit 12 immediately transmits the collection-target data information as the data collection task. Since the delay is the smallest among the delays for the pieces of collection-target data in the entry, (1) is satisfied. If the expected transmission time is time before the current time, (3) is satisfied. Thus, the above condition is satisfied. For example, the expected transmission time “1579681005” is before the current time (see a diagram on the lower right side in FIG. 4). When the expected transmission time is before the current time, the data-processing-request scheduler unit 12 immediately transmits the collection-target data information as the data collection task.

If the condition of “(1) AND ((2) OR (3))” is not satisfied when the entry is extracted, the data-processing-request scheduler unit 12 performs the process of determining a location at which the entry is re-inserted in the data processing request queue 21 in the following manner. For example, when the delay is the smallest among the delays for the pieces of collection-target data in the entry, (1) is satisfied. However, the expected transmission time is neither the initial value nor the time before the current time (the expected transmission time is the time after the current time). In such a case, (2) and (3) are not satisfied. Thus, the above condition is not satisfied. For example, this corresponds to a case where the expected transmission time “1579681005” is time after the current time (see a diagram on the lower left side in FIG. 4). When the expected transmission time is after the current time, the data-processing-request scheduler unit 12 obtains a time for which transmission is to be waited. The time for which transmission is to be waited is obtained as d′=T−T0 from expected transmission time T and current time T0.

The data-processing-request scheduler unit 12 calculates an index based on the current token supply amount and the time d′ for which transmission is to be waited, and re-inserts the entry of this collection-target data at the location corresponding to the calculated index in the data processing request queue 21. For example, in order to transmit the data collection task after the time d′ with the current token supply amount, the entry is to be inserted at the location where the cumulative number of pieces of collection-target data in the data processing request queue 21 is equal to the number (N) (=d′×TP). If the entry is inserted at this location, the inserted entry comes at the head after the time d′×TP/TP=d′. Thus, the data collection task may be transmitted with the delay d′ from the current time.

As for the calculation of the index, the data-processing-request scheduler unit 12 calculates a new index value by using N and the function f(N). The data-processing-request scheduler unit 12 re-inserts the entry at the location for the new index value in the data processing request queue 21 in which the entries are sorted in ascending order of the index value. Since the method of obtaining the function f(N) is as described above, the description thereof will be omitted.

As indicated by a graph on the lower left side in FIG. 4, a function f(x) for obtaining an index value is represented by plotting each index value in the queue and the cumulative value of the number of entries up to the entry having the index value. N is equal to (the expected transmission time−the current time)×the current token supply amount. The data-processing-request scheduler unit 12 obtains the new index value “1579681030” by using this function f(x) and N. The data-processing-request scheduler unit 12 generates an entry in which the index is set to “1579681030” and the expected transmission time is continuously set to “1579681005”. The data-processing-request scheduler unit 12 re-inserts the newly generated entry at the location indicated by the index “1579681030” in the data processing request queue 21.

Thus, even after the re-insertion illustrated in FIG. 3, the data-processing-request scheduler unit 12 is able to perform adjustment so that the data collection task may be transmitted at the expected transmission time if the expected transmission time is after the current time. As a result, the data-processing-request scheduler unit 12 may enable simultaneously reception of a plurality of pieces of data in the entry. As a result, the data-processing-request scheduler unit 12 may suppress an additional calculation resource for fully receiving the load peak and an additional storage resource for storing data waiting for being processed, and may not impose a load on the resources.

Referring back to FIG. 1, the data receiving unit 13 receives data from the data transmission source 3. The data receiving unit 13 stores the received data in the collected data store information 26. The data receiving unit 13 acquires, from the received data, a data collection ID, a geographical location of the data transmission source 3, the data size, and the like. The data receiving unit 13 acquires an entry from the data-collection-task state management information 25 by using the data collection ID as a key, and updates the entry based on the acquired information. In response to the completion of data collection for all the pieces of collection-target data information included in the data processing request (request), the data receiving unit 13 issues a trigger for performing data processing to the data processing unit 14.

The data processing unit 14 performs data processing for each data processing request. For example, the data processing unit 14 extracts the collected data for the collection-target data for each request from the collected data store information 26, and performs data processing. The data processing unit 14 returns a result of the data processing to the service 5 that has transmitted the request.

The data-transmission-source location information collecting unit 15 collects location information of the data transmission source 3. For example, the data-transmission-source location information collecting unit 15 receives location information periodically transmitted from the data transmission source 3. The data-transmission-source location information collecting unit 15 stores the received current location information as the geographical location corresponding to the data transmission source 3 in the data-transmission-source location information 23.

The statistical information generating unit 16 generates statistical information of the delay and the throughput in data transmission for each data source that is the data transmission source 3. For example, the statistical information generating unit 16 performs the following processing for each data source that is the data transmission source 3. The statistical information generating unit 16 calculates, for each geographical location, an average delay and an average throughput in data transmission. The statistical information generating unit 16 acquires an entry associated with the data transmission source and the geographical location from the statistical information 22. The statistical information generating unit 16 updates the acquired entry by using the calculated average delay and average throughput. When the statistical information generating unit 16 is unable to acquire the corresponding entry from the statistical information 22, the statistical information generating unit 16 may add a new entry.

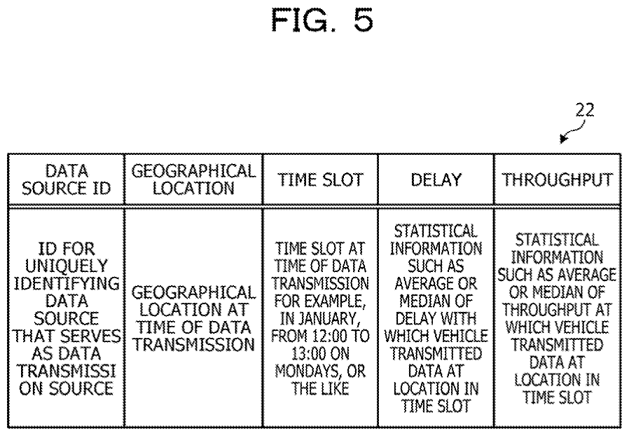

Examples of data structures of various kinds of information will be described with reference to FIGS. 5 to 9.

[Data Structure of Statistical Information]

FIG. 5 is a diagram illustrating an example of a data structure of statistical information. As illustrated in FIG. 5, the statistical information 22 stores a geographical location, a time slot, a delay, and a throughput in association with a data source ID. The data source ID is an ID for uniquely identifying a data source that serves as the data transmission source 3. The geographical location is a geographical location of the data source at the time of data transmission. The geographical location is represented by, for example, the latitude and the longitude. The time slot is a time slot when data was transmitted from the data source. The delay is statistical information on a delay with which the data source transmitted data at the geographical location in the time slot. The throughput is statistical information on a throughput at which the data source transmitted data at the geographical location in the time slot. The statistical information 22 is generated by the statistical information generating unit 16.

[Data Structure of Data-Transmission-Source Location Information]

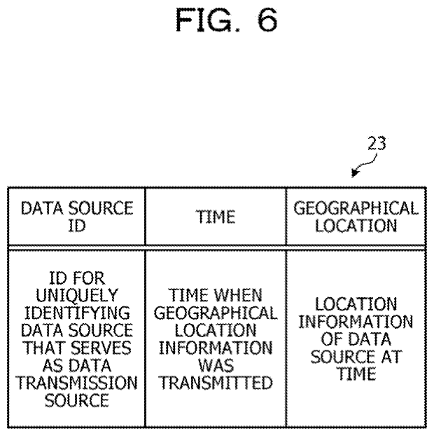

FIG. 6 is a diagram illustrating an example of a data structure of data-transmission-source location information. As illustrated in FIG. 6, the data-transmission-source location information 23 stores time and a geographical location in association with a data source ID. The data source ID is an ID for uniquely identifying a data source that serves as the data transmission source 3. The time is time when the data source transmitted the geographical location information. The geographical location is location information of the data source at the time. The geographical location is represented by, for example, the latitude and the longitude. The data-transmission-source location information 23 is updated by the data-transmission-source location information collecting unit 15.

[Data Structure of Data Information]

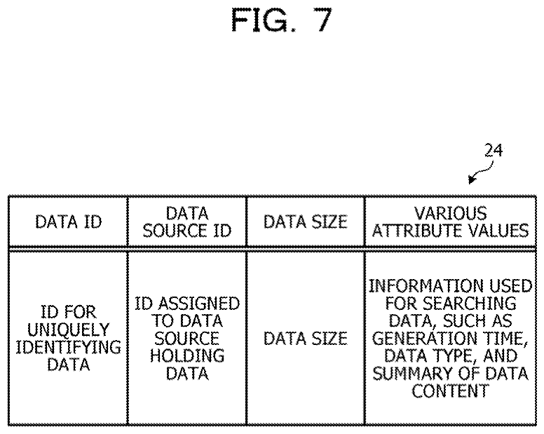

FIG. 7 is a diagram illustrating an example of a data structure of data information. As illustrated in FIG. 7, the data information 24 stores a data ID, a data source ID, a data size, and various attribute values in association with one another. The data ID is an ID for uniquely identifying data. The data source ID is an ID assigned to a data source (the data transmission source 3) that holds the data. The data size is the size of the data. The various attribute values are information used by the service 5 to search data, and are information such as generation time, a data type, and a summary of data content. The data information 24 stores information on data generated by the data transmission source 3.

[Data Structure of Data-Collection-Task State Management Information]

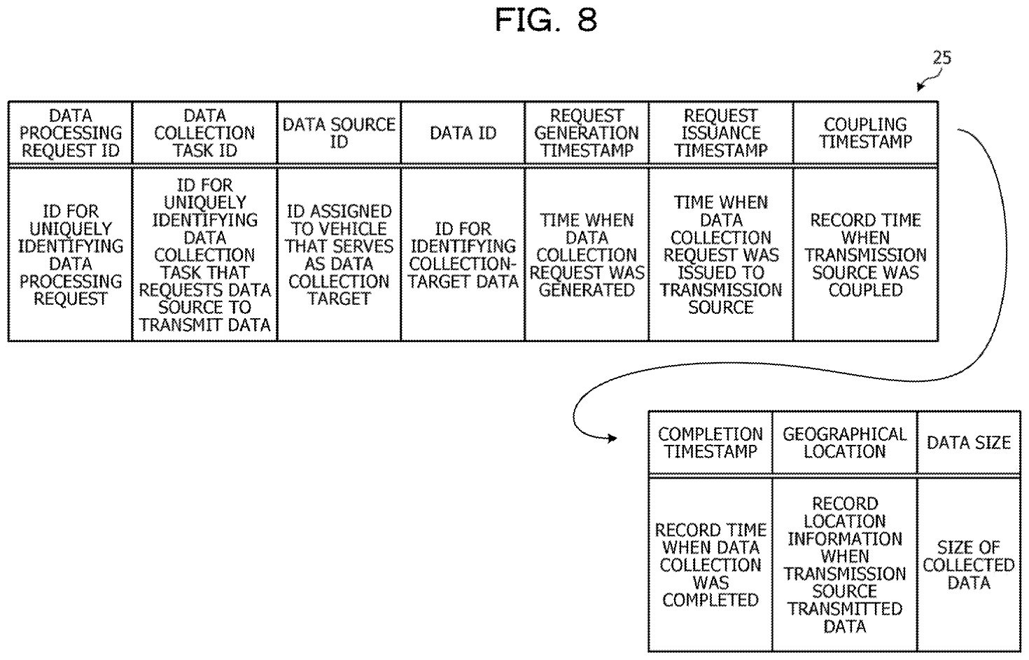

FIG. 8 is a diagram illustrating an example of a data structure of data-collection-task state management information. As illustrated in FIG. 8, the data-collection-task state management information 25 stores a data processing request ID, a data collection task ID, a data source ID, a data ID, a request generation timestamp, a request issuance timestamp, a coupling timestamp, a completion timestamp, a geographical location, and a data size in association with one another. The data processing request ID is an ID for uniquely identifying a data processing request. The data collection task ID is an ID for uniquely identifying a data collection task used when a data source is requested to transmit data. The data source ID is an ID assigned to the data source (vehicle, for example) that serves as a data collection target. The data ID is an ID for identifying collection-target data. The request generation timestamp is time when the data collection request was generated. The request issuance timestamp is time when the data collection request was issued to the data source serving as the transmission source. The coupling timestamp is time when the data source serving as the transmission source was coupled. The completion timestamp is time when data collection was completed. The geographical location is location information of the transmission source at the location information time when the data source serving as the transmission source transmitted data. The geographical location is represented by, for example, the latitude and the longitude. The data size is the size of the collected data. Each entry of the data-collection-task state management information is added by the data-processing-request scheduler unit 12 and is updated by the data receiving unit 13.

[Data Structure of Collected Data Store Information]

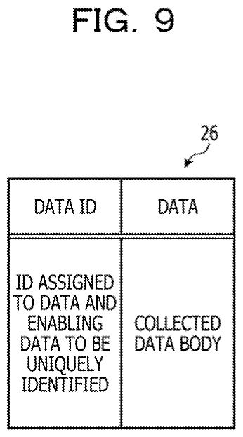

FIG. 9 is a diagram illustrating an example of a data structure of collected data store information. As illustrated in FIG. 9, the collected data store information 26 stores a data ID and data in association with each other. The data ID is an ID that is assigned to data and that enables the data to be uniquely identified. The data is a collected data body. The collected data store information 26 stores data received by the data receiving unit 13.

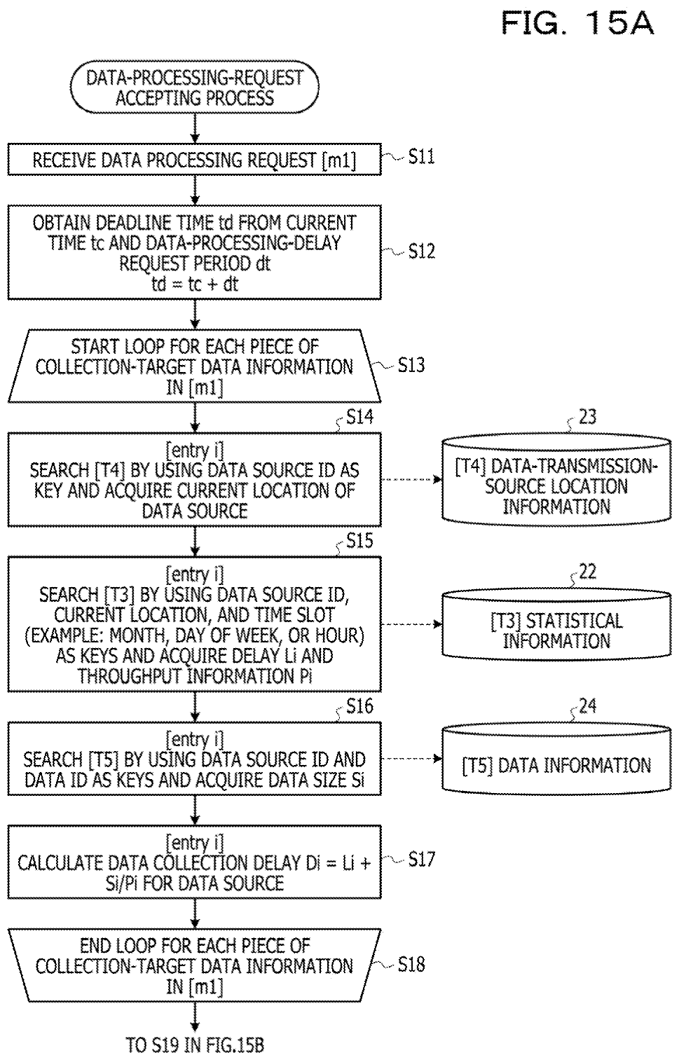

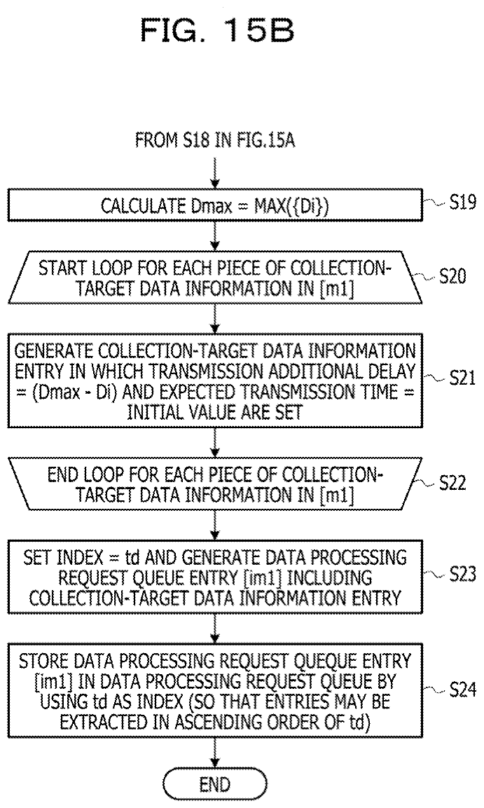

An example of flowcharts of respective processes will be described with reference to FIGS. 15A to 20. FIGS. 15A and 15B are a flowchart illustrating an example of the data-processing-request accepting process according to the embodiment.

[Flowchart of Data-Processing-Request Accepting Process]

FIGS. 15A and 15B are a flowchart illustrating an example of the data-processing-request accepting process according to the embodiment. The data-processing-request accepting unit 11 receives a data processing request (request) [m1] from the service 5 (step S11).

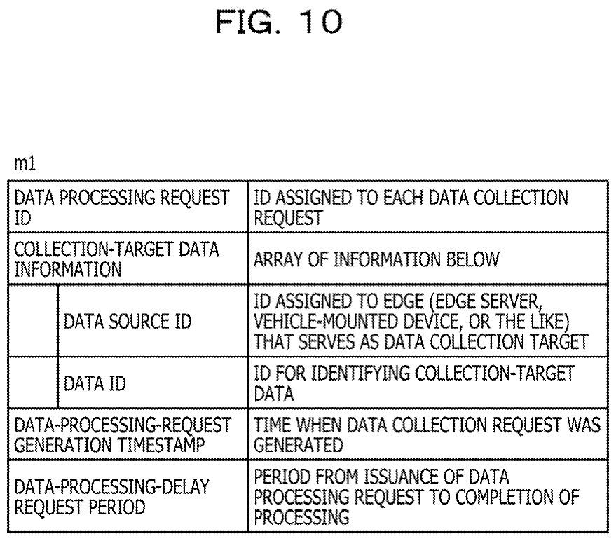

An example of the data processing request (request) will be described with reference to FIG. 10. As illustrated in FIG. 10, the data processing request is information in which collection-target data information, a data-processing-request generation timestamp, and a data-processing-delay request period are associated with a data processing request ID. The data processing request ID is an ID that is assigned to each data collection request and that enables the data processing request to be uniquely identified. The collection-target data information is an array of sets of a data source ID and a data ID. The data source ID is an ID assigned to a data source serving as a data collection target. The data ID is an ID for identifying collection-target data. The data-processing-request generation timestamp is time when the data collection request was generated. The data-processing-delay request period is a delay request period from issuance of the data processing request to completion of processing.

Referring back to FIGS. 15A and 15B, the data-processing-request accepting unit 11 obtains deadline time td (=tc+dt) from the current time tc and the data-processing-delay request period dt included in the data processing request [m1] (step S12). The data-processing-request accepting unit 11 starts the loop in order to iterate the processing up to step S18 for each piece of the collection-target data information in the data processing request [m1] (step S13). One piece of collection-target data information is hereinafter denoted as an entry i (where i=1 to the number of pieces of collection-target data information in the array).

The data-processing-request accepting unit 11 searches the data-transmission-source location information 23 ([T4]) for the collection-target data information [entry i] by using the data source ID as a key, and acquires the current location of the data source (step S14). The data-processing-request accepting unit 11 searches the statistical information 22 [T3] by using the data source ID, the current location, and the time slot as keys, and acquires a delay U and throughput information Pi (step S15). The data-processing-request accepting unit 11 searches the data information 24 [T5] by using the data source ID and the data ID as keys, and acquires a data size Si (step S16).

The data-processing-request accepting unit 11 calculates a data collection delay Di (=Li+Si/PI) for the data source (step S17). The data-processing-request accepting unit 11 causes the process to proceed to step S13 in order to process another piece of collection-target data information in the data processing request [m1] (step S18).

The data-processing-request accepting unit 11 calculates, as Dmax, the maximum data collection delay Di (step S19). The data-processing-request accepting unit 11 starts the loop in order to iterate the processing up to step S22 for each of the pieces of collection-target data information in the data processing request [m1] (step S20).

The data-processing-request accepting unit 11 generates a collection-target data information entry for the collection-target data information by setting the transmission additional delay to (Dmax−Di) and setting the expected transmission time to the initial value (step S21). The data-processing-request accepting unit 11 causes the process to proceed to step S20 in order to process another piece of collection-target data information in the data processing request [m1] (step S22).

The data-processing-request accepting unit 11 sets the index to the deadline time td, and generates a data processing request queue entry [im1] including the generated collection-target data information entry (step S23). The data-processing-request accepting unit 11 stores the generated data processing request queue entry [im1] in the data processing request queue 21 that is the priority queue by using the deadline time td as the index (step S24). From the data processing request queue 21, entries are extracted in ascending order of the deadline time td.

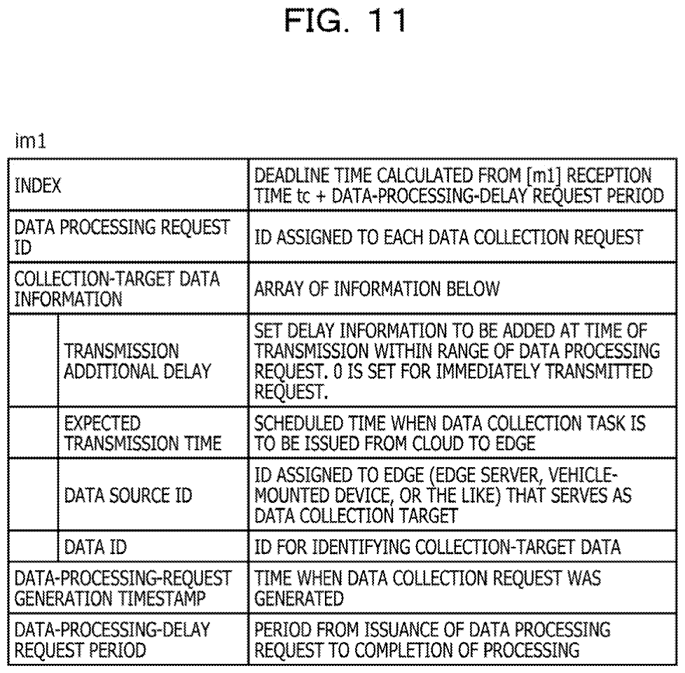

An example of the data processing request queue entry [im1] will be described with reference to FIG. 11. As illustrated in FIG. 11, the data processing request queue entry is information in which collection-target data information, a data-processing-request generation timestamp, and a data-processing-delay request period are associated with an index and a data processing request ID. The index is deadline time. The data processing request ID is the same as the data processing request ID of the data processing request [m1]. The collection-target data information is an array of sets of a transmission additional delay, expected transmission time, a data source ID, and a data ID. The transmission additional delay indicates a delay period to be added at the time of transmission in the range of the data processing request [m1]. In the case of immediate transmission, 0 is set. The expected transmission time is scheduled time when a data collection task is to be issued to the data source. The data source ID is the same as the data source ID of the data processing request [m1]. The data ID is the same as the data ID of the data processing request [m1]. The data-processing-request generation timestamp is the same as the data-processing-request generation timestamp of the data processing request [m1]. The data-processing-delay request period is the same as the data-processing-delay request period of the data processing request [m1].

[Flowchart of Data-Processing-Request Scheduler Process]

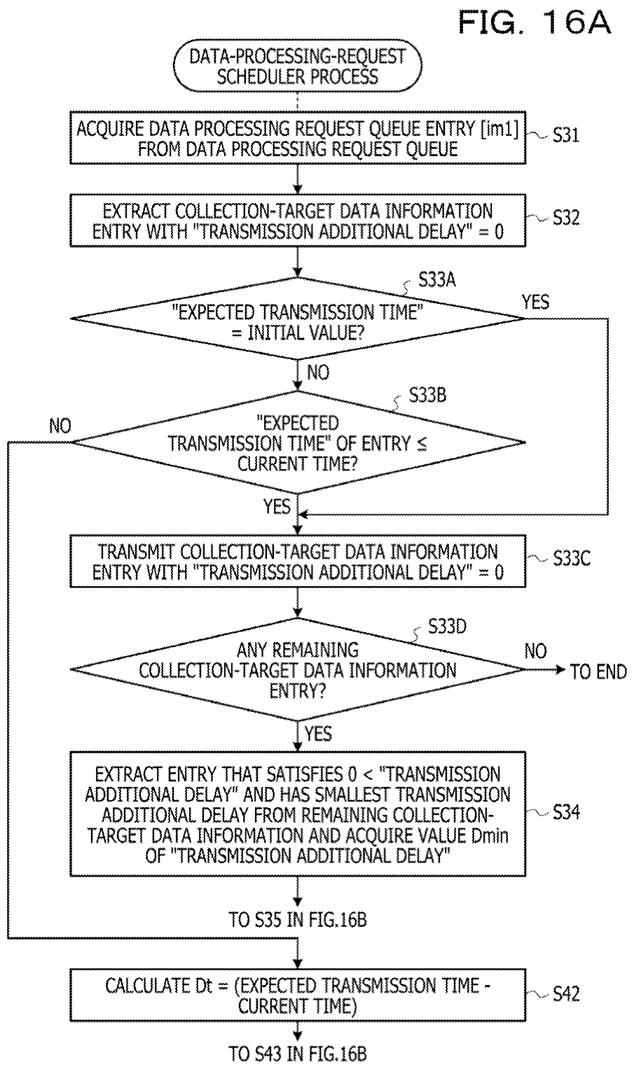

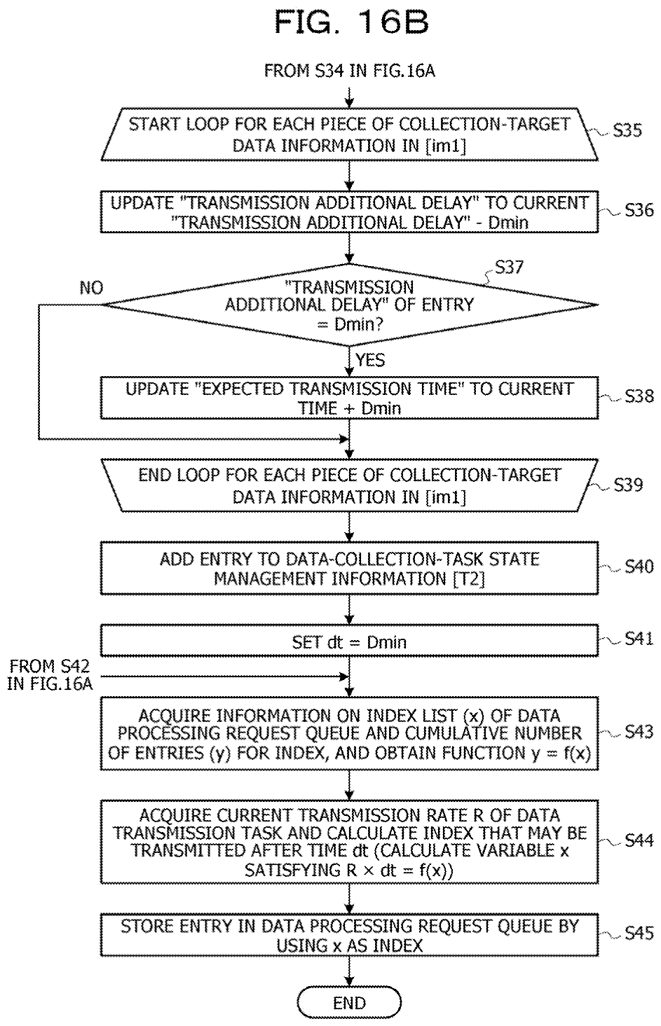

FIGS. 16A and 16B are a flowchart illustrating an example of the data-processing-request scheduler process according to the embodiment. The data-processing-request scheduler unit 12 acquires the data processing request queue entry [im1] from the data processing request queue 21 (step S31). The data-processing-request scheduler unit 12 extracts, from the data processing request queue entry [im1], a collection-target data information entry having the “transmission additional delay” of 0 (step S32).

The data-processing-request scheduler unit 12 determines whether the “expected transmission time” is the initial value (step S33A). If it is determined that the “expected transmission time” is the initial value (Yes in step S33A), the data-processing-request scheduler unit 12 causes the process to proceed to step S33C in order to transmit the collection-target data information entry.

On the other hand, if it is determined that the “expected transmission time” is not the initial value (No in step S33A), the data-processing-request scheduler unit 12 determines whether or not the “expected transmission time” of the entry is at or before the current time (step S33B). If it is determined that the “expected transmission time” of the entry is at or before the current time (Yes in step S33B), the data-processing-request scheduler unit 12 causes the process to proceed to step S33C in order to transmit the collection-target data information entry.

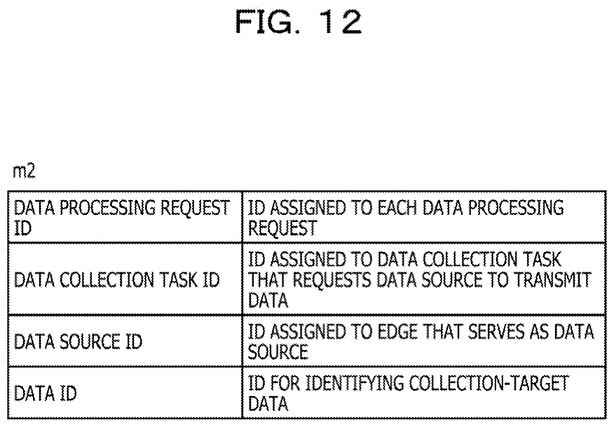

In step S33C, the data-processing-request scheduler unit 12 transmits the extracted collection-target data information entry having the “transmission additional delay” of 0 to the data transmission source 3 (step S33C). For example, for the extracted collection-target data information entry, the data-processing-request scheduler unit 12 transmits a request of the data collection task [m2] to the data transmission source 3 that is the corresponding data source. An example of a request of the data collection task for the data source will be described with reference to FIG. 12. As illustrated in FIG. 12, the request of the data collection task includes a data processing request ID, a data collection task ID, a data source ID, and a data ID. The data processing request ID is an ID assigned to each data processing request (request). The data collection task ID is an ID assigned to a data collection task. The data source ID is an ID assigned to the data transmission source 3 serving as the data source. The data ID is an ID for identifying collection-target data.

Referring back to FIGS. 16A and 168, the data-processing-request scheduler unit 12 determines whether there are collection-target data information entries remaining in the data processing request queue entry [im1](step S33D). If it is determined that there are no remaining collection-target data information entries (No in step S33D), the data-processing-request scheduler unit 12 ends the data-processing-request scheduler process.

On the other hand, if it is determined that there are remaining collection-target data information entries (Yes in step S33D), the data-processing-request scheduler unit 12 extracts the entry having the “transmission additional delay” that is greater than 0 and is the smallest from among the remaining collection-target data information entries, and acquires the value Dmin of the “transmission additional delay” of the extracted entry (step S34).

The data-processing-request scheduler unit 12 starts the loop in order to iterate the processing up to step S39 for each piece of the collection-target data information in the data processing request queue entry [im1] (step S35).

The data-processing-request scheduler unit 12 updates the “transmission additional delay” to a value obtained by subtracting Dmin from the value currently set as the “transmission additional delay” (step S36). The data-processing-request scheduler unit 12 determines whether the “transmission additional delay” of the corresponding entry of the data processing request queue entry [im1] is Dmin (step S37). If it is determined that the “transmission additional delay” is not Dmin (No in step S37), the data-processing-request scheduler unit 12 causes the process to proceed to step 939.

On the other hand, if it is determined that the “transmission additional delay” is Dmin (Yes in step S37), the data-processing-request scheduler unit 12 updates the “expected transmission time” to a value obtained by adding Dmin to the current time (step S38). The data-processing-request scheduler unit 12 causes the process to proceed to step S39. The data-processing-request scheduler unit 12 causes the process to proceed to step S35 in order to process another piece of collection-target data information in the data processing request queue entry [im1] (step S39).

The data-processing-request scheduler unit 12 adds an entry to the data-collection-task state management information [T2] 25 (step S40). The data-processing-request scheduler unit 12 sets Dmin as the delay dt (step S41). The data-processing-request scheduler unit 12 causes the process to proceed to step S43 in order to calculate a new index.

If it is determined in step S33B that the “expected transmission time” of the entry is after the current time (No in step S33B), the data-processing-request scheduler unit 12 updates the delay dt to a value obtained by subtracting the current time from the expected transmission time (step S42). The data-processing-request scheduler unit 12 causes the process to proceed to step S43 in order to calculate a new index.

In step S43, the data-processing-request scheduler unit 12 acquires information on an index list (x) of the data processing request queue 21 and the cumulative number (y) of entries (tasks) for each index, and obtains a function of y=f(x) (step S43). The data-processing-request scheduler unit 12 acquires a transmission rate R of the current data transmission task, and calculates an index that enables transmission to be performed the time dt later (step S44). For example, the data-processing-request scheduler unit 12 calculates a variable x that satisfies R×dt=f(x). The value of the variable x is the index to be calculated. The transmission rate is synonymous with the token supply amount and indicates the number of transmissions per unit time.

The data-processing-request scheduler unit 12 stores the entry by using the calculated x as the index in the data processing request queue 21 that is a priority queue (step S45). The data-processing-request scheduler unit 12 ends the data-processing-request scheduler process.

[Flowchart of Data Reception Process]

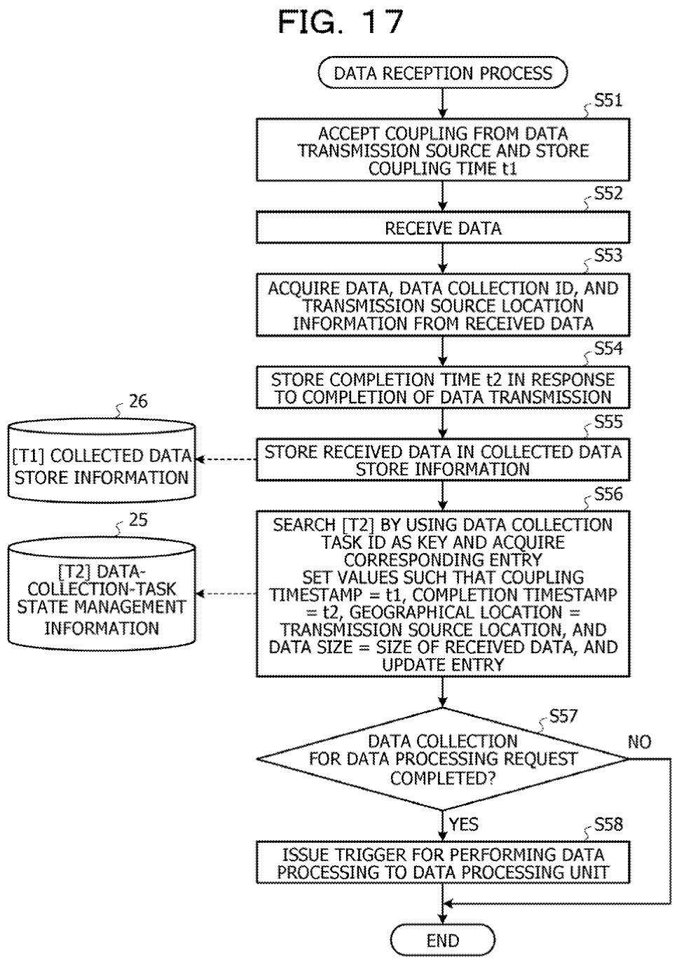

FIG. 17 is a flowchart illustrating an example of a data reception process according to the embodiment. As illustrated in FIG. 17, the data receiving unit 13 accepts coupling from the data transmission source 3 and temporarily stores coupling time t1 (step S51). The data receiving unit 13 receives data as a data collection task response [m3] (step S52).

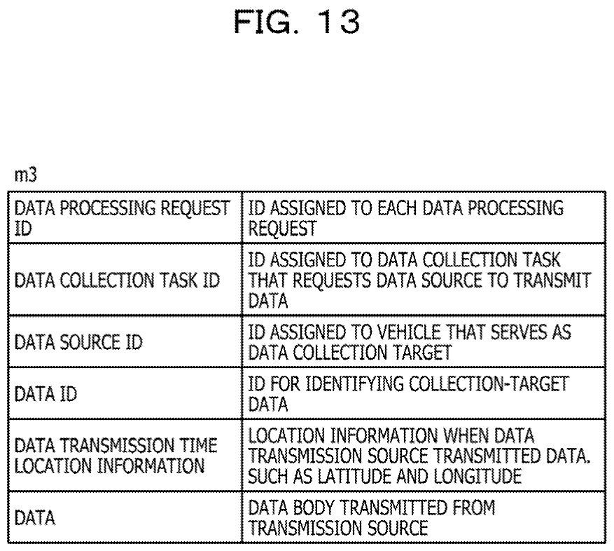

An example of the data collection task response will be described with reference to FIG. 13. As illustrated in FIG. 13, the data collection task response includes a data processing request ID, a data collection task ID, a data source ID, a data ID, data transmission time location information, and data. The data processing request ID is an ID assigned to each data processing request (request). The data collection task ID is an ID assigned to a data collection task. The data source ID is an ID assigned to the data transmission source 3 serving as the data source. The data ID is an ID for identifying collection-target data. The data transmission time location information is location information when the data transmission source 3 serving as the data source transmitted the data. The data is a data body transmitted from the transmission source.

Referring back to FIG. 17, the data receiving unit 13 acquires the data itself, the data collection task ID, and the location information of the transmission source from the received data (step S53). In response to completion of the data transmission, the data receiving unit 13 temporarily stores completion time t2 (step S54). The data receiving unit 13 stores the received data body, together with the data ID, in the collected data store information 26 (step S55).

The data receiving unit 13 searches the data-collection-task state management information [T2] 25 by using the data collection task ID as a key, and acquires the corresponding entry. The data receiving unit 13 sets values so that the coupling timestamp=t1, the completion timestamp=t2, the geographical location=the transmission source location, and the data size=the size of the received data, and updates the entry (step S56).

The data receiving unit 13 determines whether data collection for the data processing request (request) is completed (step S57). If it is determined that data collection for the data processing request (request) is not been completed (No in step S57), the data receiving unit 13 temporarily ends the data reception process.

On the other hand, if it is determined that data collection for the data processing request (request) is completed (Yes in step S57), the data receiving unit 13 issues, to the data processing unit 14, a trigger for performing data processing for the data processing request (request) (step S58). The data receiving unit 13 ends the data reception process.

[Flowchart of Data Processing Process]

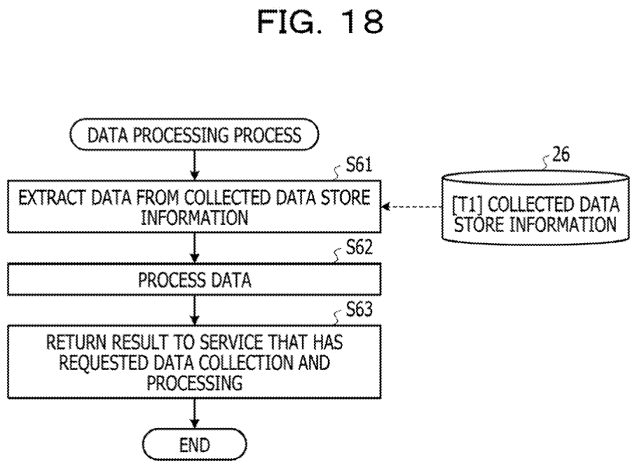

FIG. 18 is a flowchart illustrating an example of a data processing process according to the embodiment. It is assumed that a trigger for performing data processing in response to a data processing request is issued from the data receiving unit 13. As illustrated in FIG. 18, the data processing unit 14 having accepted the trigger for performing data processing in response to the data processing request (request) extracts data corresponding to the data processing request (request) from the collected data store information [T1] 26 (step S61).

The data processing unit 14 processes the extracted data (step S62). The data processing unit 14 returns a result as a response [m4] to the data processing request (request), to the service 5 that has requested the data collection and processing (step S63).

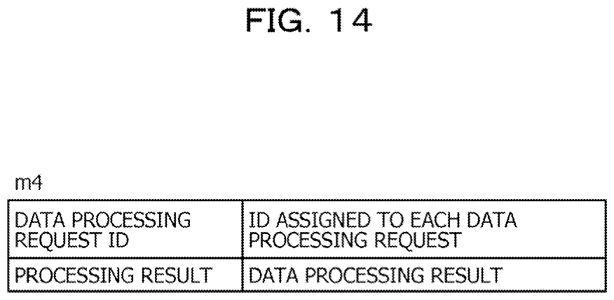

An example of the data processing request response (for the service) will be described with reference to FIG. 14. As illustrated in FIG. 14, the data processing request response for the service includes a data processing request ID and a processing result. The data processing request ID is an ID assigned to each data processing request (request). The processing result is a result of the data processing. The processing result includes data corresponding to the collection-target data information included in the data processing request (request).

[Flowchart of Transmission-Source-Location-Information Collection Process]

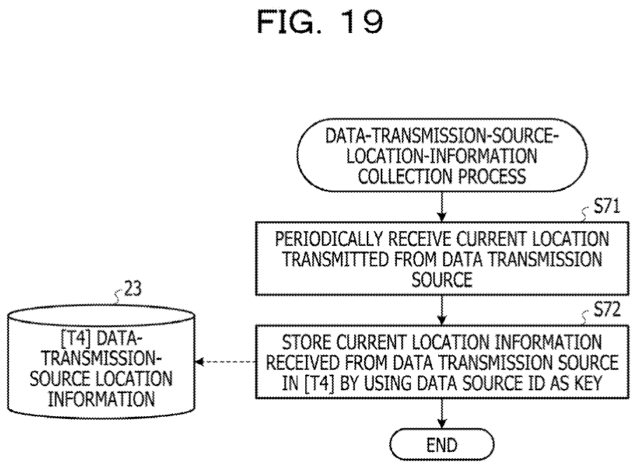

FIG. 19 is a flowchart illustrating an example of a transmission-source-location-information collection process according to the embodiment. As illustrated in FIG. 19, the data-transmission-source location information collecting unit 15 periodically receives the current location transmitted from the data transmission source 3 serving as the data source (step S71). The data-transmission-source location information collecting unit 15 stores the current location received from the data transmission source 3 in the data-transmission-source location information [T4] 23 by using the data source ID as a key (step S72).

[Flowchart of Statistical Information Generation Process]

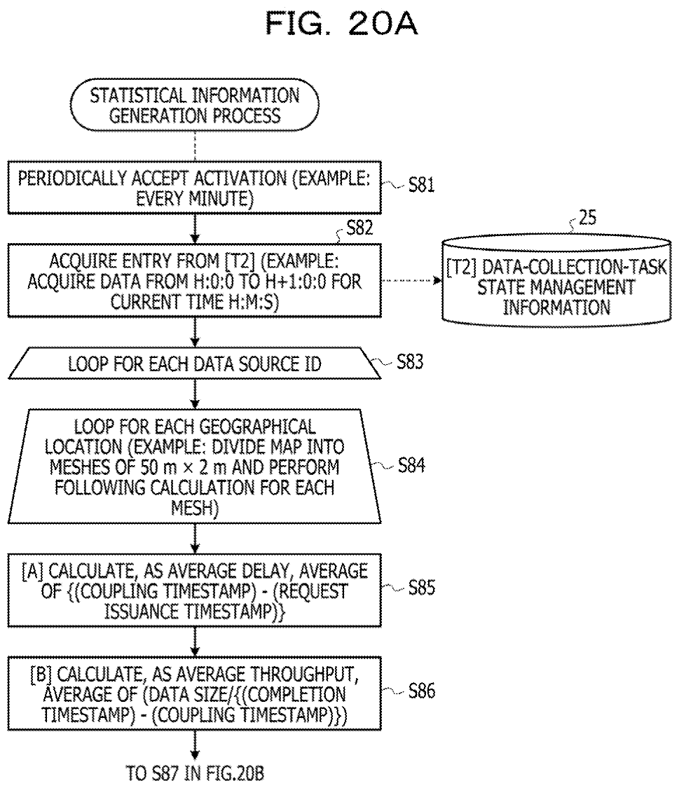

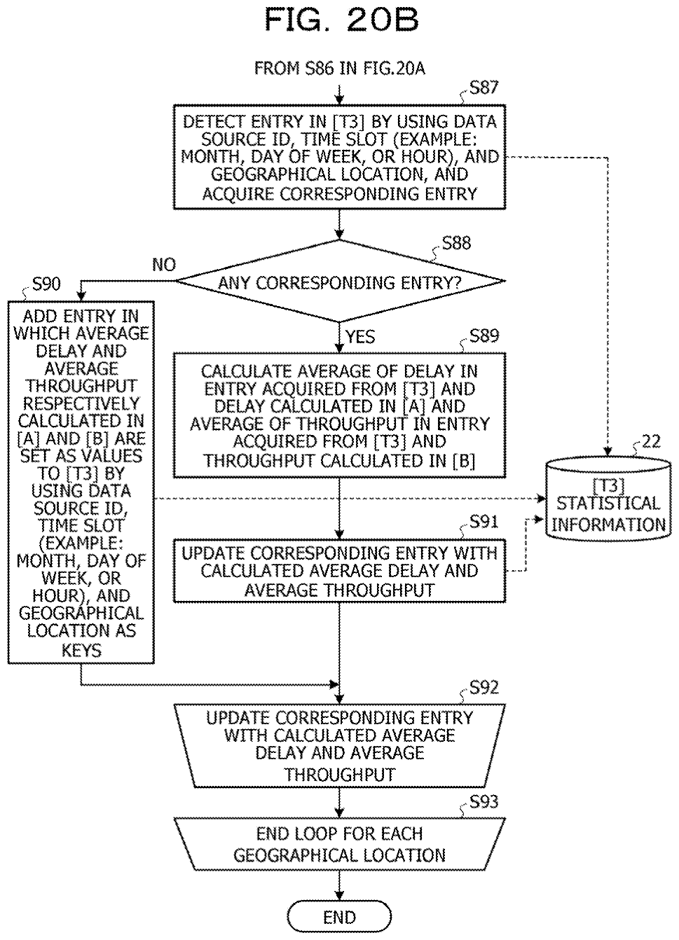

FIGS. 20A and 20B are a flowchart illustrating an example of a statistical information generation process according to the embodiment. As illustrated in FIGS. 20A and 208, the statistical information generating unit 16 periodically accepts activation (step S81). For example, the statistical information generating unit 16 accepts activation every minute. The statistical information generating unit 16 acquires an entry for which statistics are to be obtained, from the data-collection-task state management information [T2] 25 (step S82).

The statistical information generating unit 16 starts the loop in order to iterate the processing up to step S93 for each data source ID (step S83). The statistical information generating unit 16 starts the loop in order to iterate the processing up to step S92 for each geographical location (step S84). The expression “for each geographical location” used herein indicates, for example, for each mesh obtained by sectioning the map into meshes of 50 m×2 m. The statistical information generating unit 16 [A] calculates an average delay as an average of (the coupling timestamp−the request issuance timestamp) (step S85). The statistical information generating unit 16 [B] calculates an average throughput as an average of the data size/(the completion timestamp−the coupling timestamp) (step S86).

The statistical information generating unit 16 searches the statistical information [T3] 22 based on the data source ID, the time slot, and the geographical location, and acquires the corresponding entry (step S87). The statistical information generating unit 16 determines whether there is the corresponding entry (step S88). If it is determined that there is no corresponding entry (No in step S88), the statistical information generating unit 16 performs the following processing. For example, the statistical information generating unit 16 adds an entry to the statistical information [T3] 22 using, as values, the average delay and the average throughput respectively calculated in [A] and [B] by using the data source ID, the time slot, and the geographical location as keys (step S90). The statistical information generating unit 16 causes the process to proceed to step S92 in order to process the next geographical location.

On the other hand, if it is determined that there is the corresponding entry (Yes in step S88), the statistical information generating unit 16 calculates an average of the delay set in the entry acquired from the statistical information [T3] 22 and the delay calculated in [A] and an average of the throughput set in the entry acquired from the statistical information [T3] 22 and the throughput calculated in [B] (step S89). The statistical information generating unit 16 updates the corresponding entry with the calculated average delay and average throughput (step S91). The statistical information generating unit 16 causes the process to proceed to step S92 in order to process the next geographical location.

In step S92, the statistical information generating unit 16 causes the process to proceed to step S84 in order to process another geographical location for the selected data source ID (step S92). In step S93, the statistical information generating unit 16 causes the process to proceed to step S83 in order to process another data source ID.

[Effects of Embodiment]

According to the above-described embodiment, the control apparatus 1 assigns, to each request for data collection, an index based on acceptance time of the request and a delay period allowable for data collection, and inputs the request to a queue in order of the index. In a case where a transmission timing of data collection of the request is to be delayed, the control apparatus 1 extracts the request from the queue and re-inputs the request to the queue by using an index based on a period for which the transmission timing is to be delayed and an extraction pace at which requests are extracted from the queue. With such a configuration, in the case where the transmission timing of data collection of the request extracted from the queue is to be delayed, the request is re-input to the queue by using the index based on the period for which the transmission timing is to be delayed and the extraction pace at which the requests are extracted from the queue. Thus, the control apparatus 1 may implement simultaneous reception of pieces of collected data without imposing a load on resources. As a result, the control apparatus 1 may suppress an additional calculation resource for fully receiving the load peak and an additional storage resource for storing data waiting for being processed, and may not impose a load on the resources.

According to the above-described embodiment, the control apparatus 1 further adds delay periods in data collection for respective data sources to an entry that includes an index, by using the statistical information 22 that indicates communication environments of the respective data sources, and inputs the entry to which the delay periods are added to the queue in the order of the index. The control apparatus 1 identifies, from among the delay periods for the respective data sources in an entry extracted from the queue in the order of the index, a delay period, for a data source, that indicates that a transmission timing of data collection is to be delayed. The control apparatus 1 calculates an index, based on the identified delay period for the data source and the current extraction pace, and re-inputs the entry to the queue by using the calculated index. With such a configuration, the control apparatus 1 calculates the index for the data source for which the timing is to be delayed, by using the delay period and the current extraction pace, and re-inputs the entry to the queue by using this index. Thus, the control apparatus 1 may implement simultaneous reception of pieces of collected data from the data sources in the entry.

According to the above-described embodiment, the control apparatus 1 calculates expected transmission time, based on the delay period and current time. The control apparatus 1 updates the expected transmission time of the entry in accordance with the index. With such a configuration, the control apparatus 1 updates the expected transmission time in accordance with the index. Thus, when the entry is extracted next time by using the index at the current extraction pace, the time when the entry is extracted substantially matches the expected transmission time. When the request may be transmitted at the expected transmission time, pieces of collected data may be simultaneously received.

According to the above-described embodiment, the control apparatus 1 further extracts an entry from the queue in the order of the index. In a case where the expected transmission time included in the extracted entry is after the current time, the control apparatus 1 re-calculates the index, based on the expected transmission time, the current time, and the current extraction pace. The control apparatus 1 re-inputs the entry to the queue by using the calculated index. With such a configuration, even when the current extraction pace varies from the extraction pace at the time of the update of the expected transmission time, the control apparatus 1 corrects the index by using the current extraction pace and re-inputs the entry to the queue by using the corrected index. Thus, the control apparatus 1 may simultaneously receive pieces of collected data.

[Others]

The control apparatus 1 may be implemented by causing an information processing apparatus such as a known personal computer or workstation to be equipped with the individual functions. The individual functions are the data-processing-request accepting unit 11, the data-processing-request scheduler unit 12, the data receiving unit 13, the data processing unit 14, the data-transmission-source location information collecting unit 15, the statistical information generating unit 16, and the like described above. The control apparatus 1 is not limited to the information processing apparatus, and may be a distributed data collection system including apparatuses to which the individual functions are deployed separately.

The components of each apparatus illustrated in the drawings do not have to be physically configured as illustrated. For example, specific forms of dispersion and integration of the apparatuses are not limited to those illustrated in the drawings, and all or part thereof may be configured by being functionally or physically dispersed or integrated in arbitrary units according to various loads, the state of use, and the like. For example, the data-processing-request accepting unit 11 and the data-processing-request scheduler unit 12 may be integrated as one unit. On the other hand, the data-processing-request accepting unit 11 may be distributed to an accepting unit that accepts a data processing request (request), a generating unit that generates a data processing request queue entry, and an input unit that inputs the data processing request queue entry to the data processing request queue 21. Each piece of information may be coupled via a network as an external device of the control apparatus 1.

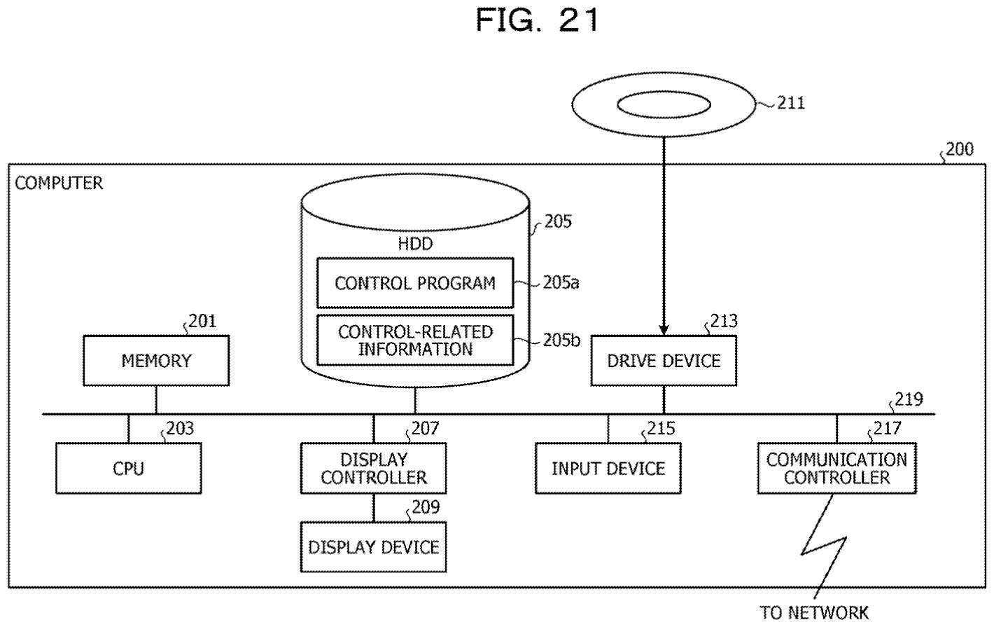

The various processes described in the embodiment above may be implemented as a result of a computer such as a personal computer or a workstation executing a program prepared in advance. Hereinafter, an example of a computer that executes a control program for implementing substantially the same functions as those of the control apparatus 1 illustrated in FIG. 1 will be described. FIG. 21 is a diagram illustrating an example of a computer that executes a control program.

As illustrated in FIG. 21, a computer 200 includes a central processing unit (CPU) 203 that performs various kinds of arithmetic processing, an input device 215 that accepts input of data from a user, and a display controller 207 that controls a display device 209. The computer 200 also includes a drive device 213 that reads a program or the like from a storage medium, and a communication controller 217 that exchanges data with another computer via a network. The computer 200 also includes a memory 201 that temporarily stores various kinds of information, and a hard disk drive (HDD) 205. The memory 201, the CPU 203, the HDD 205, the display controller 207, the drive device 213, the input device 215, and the communication controller 217 are coupled to one another via a bus 219.

The drive device 213 is, for example, a device for a removable disk 211. The HDD 205 stores a control program 205a and control-related information 205b.

The CPU 203 reads the control program 205a, loads the control program 205a into the memory 201, and executes the control program 205a as processes. Such processes correspond to the respective functional units of the control apparatus 1. The control-related information 205b corresponds to the data processing request queue 21, the statistical information 22, the data-transmission-source location information 23, the data information 24, the data-collection-task state management information 25, and the collected data store information 26. For example, the removable disk 211 stores various kinds of information such as the control program 205a.

The control program 205a does not necessarily have to be initially stored in the HDD 205. For example, the control program 205a is stored in a “portable physical medium”, such as a flexible disk (FD), a compact disc read-only memory (CD-ROM), a digital versatile disc (DVD), a magneto-optical disk, or an integrated circuit (IC) card, to be inserted into the computer 200. The computer 200 may read and execute the control program 205a from these media.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A task control apparatus comprising:
a memory; and
a processor coupled to the memory and configured to:
assign, to each request for data collection, an index based on acceptance time and a delay period allowable in data collection;
input the request to a queue in order of the index;
extract, in a case where a transmission timing of data collection of the request is to be delayed, the request from the queue; and
re-input the request to the queue by using an index based on a period for which the transmission timing is to be delayed and an extraction pace at which requests are extracted from the queue.

2. The task control apparatus according to claim 1, wherein
the processor further
adds delay periods in data collection for respective data sources to an entry that includes an index, by using information that indicates communication environments of the respective data sources,
inputs the entry to which the delay periods are added to the queue in the order of the index,
identify, from among the delay periods for the respective data sources in an entry extracted from the queue in the order of the index, a delay period, for a data source, that indicates that a transmission timing of data collection is to be delayed,
calculate an index, based on the identified delay period for the data source and the current extraction pace, and
re-input the entry to the queue by using the calculated index.

3. The task control apparatus according to claim 2, wherein
the processor calculates expected transmission time, based on the delay period and current time, and updates the expected transmission time of the entry in accordance with the index.

4. The task control apparatus according to claim 3, wherein
the processor further
extracts an entry from the queue in the order of the index,
in a case where the expected transmission time included in the extracted entry is after the current time, re-calculates an index, based on the expected transmission time, the current time, and the current extraction pace, and
re-inputs the entry to the queue by using the calculated index.

5. A task control method comprising:
assigning, to each request for data collection, an index based on acceptance time and a delay period allowable in data collection;
inputting the request to a queue in order of the index;
extracting, in a case where a transmission timing of data collection of the request is to be delayed, the request from the queue; and
re-inputting the request to the queue by using an index based on a period for which the transmission timing is to be delayed and an extraction pace at which requests are extracted from the queue.
